(19) United States
(12) Patent Application Publication
(10) Pub. No.: US 2009/0047939 A1
(43) Pub. Date: Feb. 19, 2009

(54) Method and Apparatus for Signaling a Call From a Caller Terminal to a Callee Terminal

(76) Inventors: Ahmad M. Jrad, Red Bank, NJ (US); Gerard P. O'Reilly, Manalapan, NJ (US); Himanshu Pant, Holmdel, NJ (US); Steven H. Richman, Highland Park, NJ (US)

Correspondence Address: PATTERSON & SHERIDAN, LLP/;LUCENT TECHNOLOGIES, INC, 595 SHREWSBURY AVENUE, SHREWSBURY, NJ, 07702, US

(21) Appl. No.: 11/838,349

(22) Filed: Aug. 14, 2007

(51) Int. Cl. H04Q 7/38

(52) U.S. Cl. 455/417

(57) ABSTRACT

The invention includes a method and apparatus for establishing a call from a caller to a callee. A method includes monitoring call establishment signaling associated with a request by a caller to establish a call from a first terminal of the caller to a first terminal of the callee, determining a location of each of at least one condition in the network, and routing the call establishment signaling to at least one of a second terminal of the caller and a second terminal of the callee based on the location of each of the at least one condition in the network. A method includes monitoring call establishment signaling associated with a request to establish a call from the caller to the callee, and routing the call establishment request signaling from one of a plurality of terminals of the caller toward one of a plurality of terminals of the callee.

### FIELD OF THE INVENTION

The invention relates to the field of communication networks and, more specifically, to establishing a connection between user terminals.

### BACKGROUND OF THE INVENTION

Changes in subscriber behavior can affect the state of telecommunications networks, possibly causing significant congestion and, hence, blocked calls. For this reason, telecommunications providers often go to great lengths to prepare the network for special events and days, e.g., Mother's Day, when subscriber behavior is expected to be different than normal. However, when changes in subscriber behavior are unexpected, e.g., due to some emergency situation, telecommunications networks are more likely to experience network congestion. Furthermore, network congestion may be exacerbated if the emergency situation causes failure of components of the telecommunications networks. Under such conditions, emergency calls, such as 911 calls, may be delayed or even blocked, possibly resulting in further stress on the network as subscribers reattempt emergency calls.

Today, while the Public Switched Telephone Network (PSTN) and the Mobile Wireless Network (MWN) are connected at the subscriber level, e.g., subscribers to PSTN-based service can call subscribers to MWN-based service, these networks operate independently of one another on the equipment level, i.e., neither network can automatically forward calls to the other network. For this reason, when a calling subscriber is unable to make a call to a called subscriber's wireline phone, the calling subscriber will often repeat trying to make the call to the called subscriber's wireless phone, especially if the call is important, e.g., during an emergency. Disadvantageously, the decision by the calling subscriber to repeat the call to called subscriber's wireless phone is left to the discretion of the calling subscriber, and requires the calling subscriber to know both the wireline and wireless telephone numbers of the called subscriber. Furthermore, during an emergency, precious time may be lost if the calling subscriber must redial the originally-dialed number of the called subscriber from a different phone, or must dial a different number of the called subscriber.

### SUMMARY OF THE INVENTION

Various deficiencies in the prior art are addressed through the invention of a method and apparatus for establishing a call from a caller to a callee by monitoring call establishment signaling associated with a request to establish a call from a first terminal of the caller to a first terminal of the callee, determining a location of at least one condition in the network, and routing the call establishment signaling to at least one of a second terminal of the caller and a second terminal of the callee based on the location(s) of the condition(s) in the network. For example, using the present invention, call establishment signaling for a call initiated from a wireline phone of the caller to a wireline phone of the callee may be automatically routed from the wireline phone of the caller to a wireless phone of the caller and/or from the wireline phone of the callee to a wireless phone of the callee.

When a call is routed from a first terminal of the caller, e.g., a wireline phone, to a second terminal of the caller, e.g., a wireless phone, the caller may hear an announcement on the wireline phone informing the caller that the call cannot be completed using the caller's wireline phone and is instead being routed to the caller's wireless phone. The announcement provided to the caller's wireline phone would inform the caller that the ringing of the wireless phone is not a different call, but, rather, is a continuation of the call initiated by the caller using the wireline phone. Such an announcement may be particularly helpful during an emergency situation in which the caller may be more likely to ignore what the caller would otherwise believe to be a different call initiated by someone else.

The increased call completion capabilities of the present invention are automatic and, thus, do not require called users to activate call forwarding instructions and, further, do not require calling users to attempt calls from different user terminals. Thus, by enabling more robust call establishment signaling, the present invention provides increased, and more efficient, call completion during network conditions, such as network congestion or failure conditions, e.g., during unexpected emergencies, non-emergency overload conditions, and the like, network blocking or line blocking under normal network conditions, and like network conditions, as well as various combinations thereof.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communication network;

FIG. 2 depicts a high-level block diagram of the communication network of FIG. 1 showing potential communication paths which may be established in accordance with the present invention;

FIG. 3 depicts a method according to one embodiment of the present invention;

FIG. 4 depicts a method according to one embodiment of the present invention; and

FIG. 5 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention provides increased call completion during network conditions. The increased call completion capabilities of the present invention are automatic and, thus, do not require called users to activate call forwarding instructions and, further, do not require calling users to reattempt calls from different user terminals. In other words, the present invention provides increased, and more efficient, call completion during network conditions, such as network congestion or failure conditions (e.g., during unexpected emergencies, non-emergency overload conditions, and the like), network blocking or line blocking under normal network conditions, and the like, as well as various combinations thereof. The present invention may provide automatic call completion using an available call completion path or, more optimally, using an optimal path identified from multiple available call completion paths. The present invention uses signaling networks and databases in order to control call completion, as depicted and described herein.

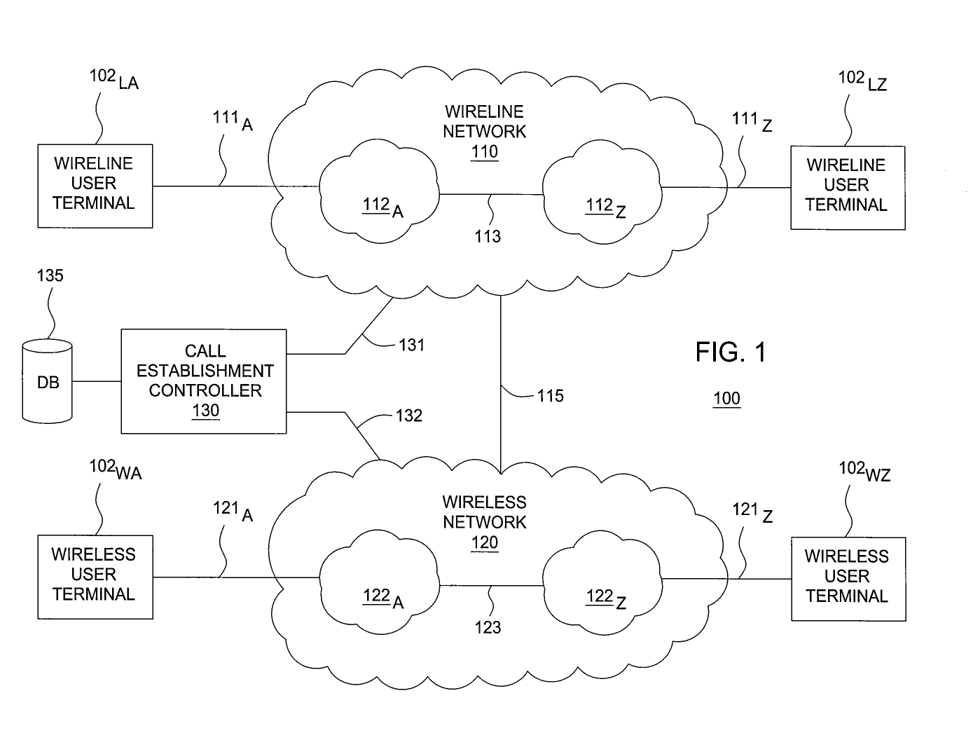

FIG. 1 depicts a high-level block diagram of a communication network.

Specifically, communication network 100 includes a wireline network 110 and a wireless network 120. As depicted in FIG. 1, wireline network 110 includes a first wireline network portion 112_{A} and a second wireline network portion 112_{Z} (also denoted herein as the caller side and callee side of the wireline network, respectively) and wireless network 120 includes a first wireless network portion 122_{A} and a second wireless network portion 122_{Z} (also denoted herein as the caller side and callee side of the wireless network, respectively). The communications network 100 supports a first wireline user terminal 102_{LA} and a first wireless user terminal 102_{WA} associated with a first user (denoted herein as the calling party or caller), a second wireline user terminal 102_{LZ} and a second wireless user terminal 102_{WZ} associated with a second user (denoted herein as the called party or callee), a wireline network 110, and a wireless network 120.

As depicted in FIG. 1, wireline user terminal 102_{LA} communicates with caller side of the wireline network 112_{A} using a wireline communication path 111_{A} and wireline user terminal 102_{LZ} communicates with callee side of the wireline network 112_{Z} using a wireline communication path 111_{Z}. As depicted in FIG. 1, wireless user terminal 102_{WA} communicates with caller side of the wireless network 122_{A} using a wireless communication path 121_{A} and wireless user terminal 102_{WZ} communicates with callee side of the wireless network 112_{Z} using a wireless communication path 121_{Z}. The caller side of the wireline network 112_{A} and callee side of the wireline network 112_{Z} communicate using a communication path 113. The caller side of the wireless network 122_{A} and callee side of the wireline network 122_{Z} communicate using a communication path 123. The wireline network 10 and wireless network 120 communicate using a communication path 115 (which may include one or more signaling connection/transfer points which are omitted for purposes of clarity).

As depicted in FIG. 1, communication network 100 includes a call establishment controller (CEC) 130. The CEC 130 communicates with wireline network 110 using a communication path 131. The CEC 130 communicates with wireless network 120 using a communication path 132. The CEC 130 monitors call establishment signaling in wireline network 110 and wireless network 120, thereby enabling CEC 130 to identify conditions in the network that require changes to routing of call establishment signaling (which may be referred to herein as routing or rerouting). The CEC 130 identifies additional user terminals associated with callers and callees for use in routing call establishment requests. The CEC 130 may also reroute call establishment requests between wireline network 110 and wireless network 120. The CEC 130 may perform various other functions of the present invention, as depicted and described herein.

In one embodiment, CEC 130 may identify an additional user terminal associated with a user locally (e.g., using local database 135). In one embodiment, CEC 130 may identify an additional user terminal associated with a user remotely (e.g., querying one or more components of wireline network 110 in order to identify a wireline user terminal, querying one or more components of wireless network 120 in order to identify a wireless user terminal, and the like, as well as various combinations thereof). The CEC 130 may identify one or more additional user terminals associated with a callee and/or may identify one or more additional user terminals associated with a caller, thereby enabling call establishment signaling to be routed from any caller terminal (one of one or more available caller terminals) to any callee terminal (one of one or more available caller terminals).

For example, given a wireline telephone number for a wireline user terminal of a callee, CEC 130 may identify a wireless telephone number for a wireless user terminal of the callee. In one such example, CEC 130 may determine the wireless number of the callee by querying database 135 using an identifier associated with the callee. In another such embodiment, CEC 130 may determine the wireless number of the callee by querying a component of wireline network 110 (e.g., a user profile database, a user subscription database, and the like) using an identifier associated with the callee. In another such embodiment, CEC 130 may determine the wireless number of the callee by querying a component of wireless network 120 (e.g., a home location register (HLR), a visitor location register (VLR), and the like) using an identifier associated with the callee. In such embodiments, the identifier associated with the callee that is used to determine the wireless number of the callee may be a user identifier, a customer number, a terminal identifier, a terminal address, the wireline number of the callee, and like callee-identifying information, as well as various combinations thereof.

For example, given a wireless telephone number for a wireless user terminal of a caller, CEC 130 may identify a wireline telephone number for a wireline user terminal of the caller. In one such example, CEC 130 may determine the wireline number of the caller by querying database 135 using an identifier associated with the caller. In another such embodiment, CEC 130 may determine the wireline number of the caller by querying a component of wireless network 120 (e.g., a home location register (HLR), a visitor location register (VLR), and the like) using an identifier associated with the caller. In another such embodiment, CEC 130 may determine the wireless number of the caller by querying a component of wireline network 110 (e.g., a user profile database, a user subscription database, and the like) using an identifier associated with the caller. In such embodiments, the identifier associated with the caller that is used to determine the wireline number of the caller may be a user identifier, a customer number, a terminal identifier, a terminal address, the wireless number of the caller, and like caller-identifying information, as well as various combinations thereof.

As described herein, the caller initiates a call to the callee. The caller may initiate the call using the wireline caller terminal 102_{LA} or the wireless caller terminal 102_{WA}. The caller may initiate the call to the wireline callee terminal 102_{LZ} or the wireless callee terminal 102_{WZ}. For purposes of clarity, the present invention is primarily described within the context of a call initiated from wireline caller terminal 102_{LA} to wireline callee terminal 102_{LZ}. Using the present invention, this call may be completed from either the wireline caller terminal 102_{LA} or the wireless caller terminal 102_{WA} to either the wireline callee terminal 102_{LZ} or the wireless callee terminal 102_{WZ}, depending on the condition of wireline network 110 (including individual network portions 112_{A} and 112_{Z}) and the condition of wireless network 120 (including individual network portions 122_{A} and 122_{Z}), as well as the condition of communication path 115 which couples wireline network 110 and wireless network 120.

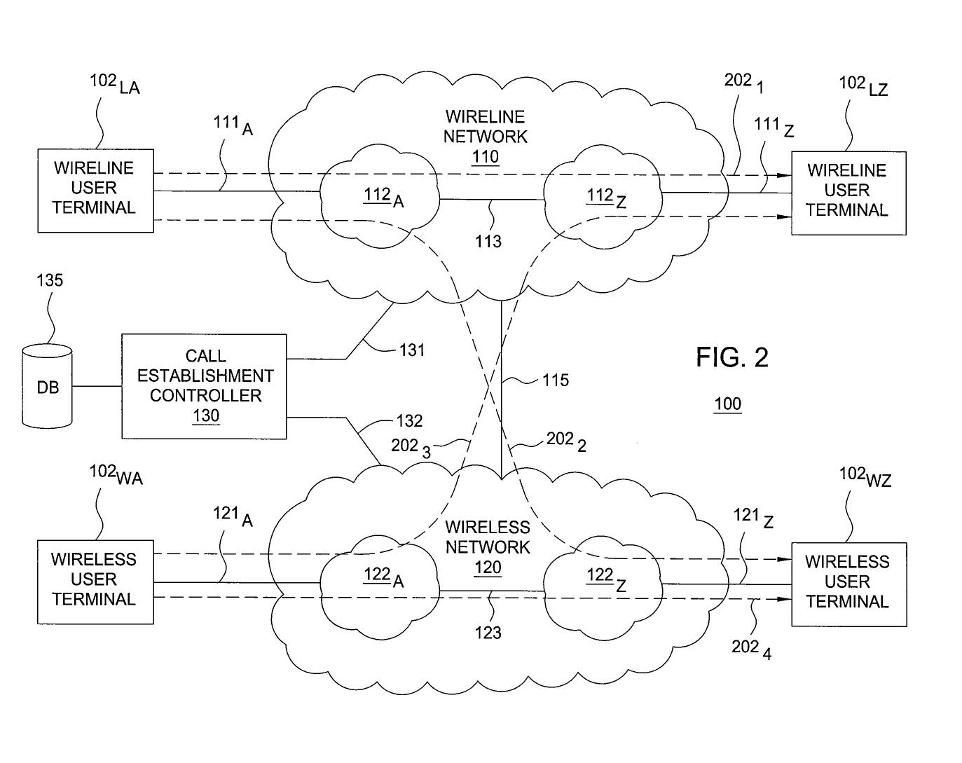

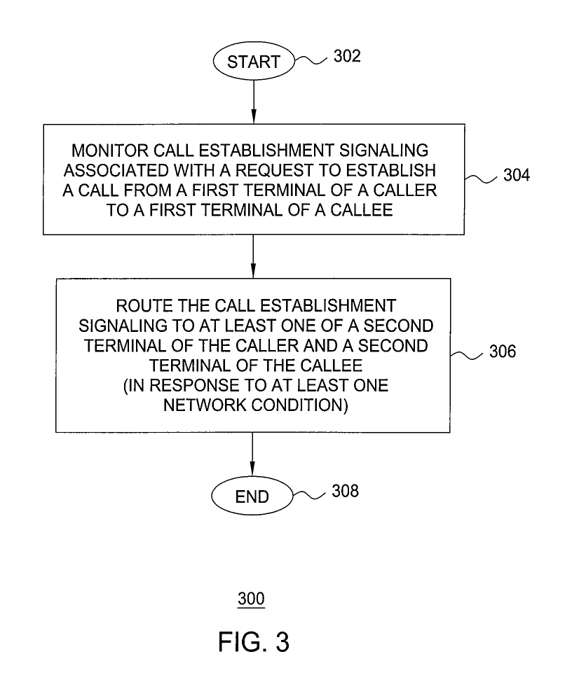

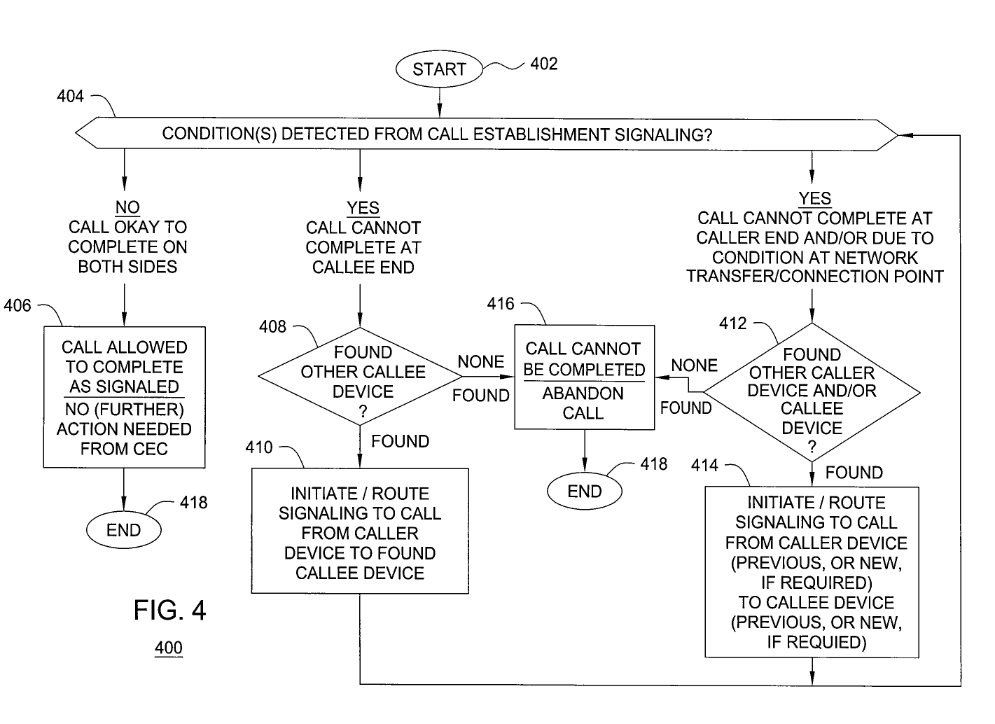

The present invention may be better understood with respect to the specific examples depicted and described with respect to FIG. 2, as well as the more general methods depicted and described with respect to FIG. 3 and FIG. 4. Specifically, the different combinations of connections which may be established in accordance with the present invention (for any of one or more caller terminals to any of one or more callee terminals) may be better understood with respect to the specific examples of FIG. 2, as well as the more general methods of FIG. 3 and FIG. 4. Similarly, various other functions of the present invention, such as call establishment signaling monitoring, user terminal identification, call establishment signaling routing, and like functions may be better understood with respect to the specific examples of FIG. 2, as well as the more general methods of FIG. 3 and FIG. 4

FIG. 2 depicts a high-level block diagram of the communication network of FIG. 1 showing potential communication paths which may be established using the present invention. As depicted in FIG. 2, using the present invention, a first communication path 202₁ may be established from wireline caller terminal 102_{LA} to wireline callee terminal 102_{LZ}, a second communication path 202₂ may be established from wireline caller terminal 102_{LA} to wireless callee terminal 102_{WZ}, a third communication path 202₃ may be established from wireless caller terminal 102_{WA} to wireline callee terminal 102_{LZ}, or a fourth communication path 202₄ may be established from wireless caller terminal 102_{WA} to wireless callee terminal 102_{WZ}.

As described herein, the communication path that is established (i.e., one of communication paths 202) is dependent on a number of factors. The communication path 202 that is established depends on the connection which the caller initially attempts to establish (e.g., wireline-to-wireline, wireless-to-wireline, and the like). The communication path 202 that is established depends on the state of communication network 100. Specifically, communication path 202 that is established depends on whether or not a condition (or conditions) is present in communication network 100 as the call establishment request is signaled from the caller to the callee. The condition(s) may affect one or more of the caller side of the wireline network 112_{A}, callee side of the wireline network 112_{Z}, caller side of the wireless network 122_{A}, callee side of the wireless network 122_{Z}, and communication path 115 by which wireline network 110 and wireless network 120 communicate.

As depicted in FIG. 2, for purposes of clarity, assume that the caller initiates a call from the wireline caller terminal 102_{LA} to the wireline callee terminal 102_{LZ}. This call attempt results in initiation of a call establishment request from the wireline caller terminal 102_{LA} intended for the wireline callee terminal 102_{LZ}. The call establishment request results in call establishment signaling within wireline network 110 and, potentially, depending upon the state of wireline network 110, also within wireless network 120 (and possibly between wireline network 110 and wireless network 120). As described herein, communication path 202 that is established depends on the connection which the caller initially attempts to establish, and the presence (or absence) of conditions in communication network 100 (including respective locations of conditions in communication network 100).

The call establishment request follows first communication path 202, if CEC 130 does not detect any conditions in the caller side of the wireline network 112_{A} or the callee side of the wireline network 112_{Z}. In this case, the call establishment request is propagated from the wireline caller terminal 102_{LA} to the wireline callee terminal 102_{LZ} using the wireline network 110 (i.e., this is standard call establishment signaling in which the call is completed as dialed from the wireline caller terminal 102_{LA} to the wireline callee terminal 102_{LZ}, which is presented here for purposes of completeness). The other communication paths 202₂-202₄ may be used to propagate the call establishment request when the call establishment request must be rerouted around one or more network conditions using at least a portion of the wireless network 120.

The call establishment request follows second communication path 202₂ if CEC 130 does not detect any conditions in the caller side of the wireline network 112_{A}, detects a condition in the callee side of the wireline network 112_{Z}, does not detect a condition on communication path 115, and does not detect a condition in the callee side of the wireless network 122_{Z}. In this case, CEC 130 identifies the wireless callee terminal 102_{WZ} of the caller. In this case, the call establishment request is propagated from the wireline caller terminal 102_{LA} to the wireline callee terminal 102_{LZ} using the caller side of the wireline network 112_{A}, communication path 115 from wireline network 110 to wireless network 120 (to the callee side of the wireless network 122_{Z}, and, optionally, also via the caller side of the wireless network 122_{A}), and the callee side of the wireless network 122_{Z} (illustratively, second communication path 202₂).

The call establishment request follows the third communication path 202₃ if CEC 130 detects a condition on the caller side of the wireline network 112_{A}, does not detect a condition in the caller side of the wireless network 122_{Z}, does not detect a condition on communication path 115, and does not detect a condition in the callee side of the wireline network 112_{Z}. In this case, CEC 130 identifies the wireless caller terminal 102_{WA} of the caller and signals wireless caller terminal 102_{WA}. The call establishment request is propagated to the wireline callee terminal 102_{LZ} using the caller side of the wireless network 122_{A}, communication path 115 from wireless network 120 to wireline network 110 (to the callee side of the wireline network 112_{Z}), and the callee side of the wireline network 112_{Z} (illustratively, third communication path 202₃).

The call establishment request follows the fourth communication path 202₄ if CEC 130 detects a condition on the caller side of the wireline network 112_{A}, does not detect a condition in the caller side of the wireless network 122_{Z}, detects a condition on communication path 115 or in the callee side of the wireline network 112_{A}, and does not detect a condition in the callee side of the wireless network 112_{Z}. In this case, CEC 130 identifies the wireless caller terminal 102_{WA} of the caller and signals wireless caller terminal 102_{WA}. The CEC 130 also identifies the wireless callee terminal 102_{WZ} of the callee. The call establishment request is propagated to the wireless callee terminal 102_{WZ} using the wireless network 120 (illustratively, fourth communication path 202₄).

In one embodiment, in which CEC 130 signals a different calling terminal than the calling terminal from which the caller initiated the call establishment request (illustratively, communications paths 202₃ and 202₄, in which the call is switched from wireline caller terminal 102_{LA} to wireless caller terminal 102_{WA}), CEC 130 may generate one or more notification messages to be propagated to the calling terminal from which the caller initiated the call establishment request in order to inform the caller that the call is being switched to a different caller terminal. The message may be a message presented in human perceptible form. For example, CEC 130 may propagate an audio notification such as THIS CALL IS BEING FORWARDED TO YOUR WIRELESS DEVICE. PLEASE ANSWER YOUR WIRELESS DEVICE TO CONTINUE THIS CALL, thereby informing the caller that the ringing of his or her wireless device is not a different call, but, rather, is an automatic transfer of the current call attempt from the wireline caller terminal to the wireless caller terminal.

The call establishment request cannot be propagated from the caller to the callee if CEC 130 detects a combination of conditions which does not allow the call establishment request to be routed from any of the caller terminals to any of the callee terminals. For example, the call establishment request cannot be propagated if CEC 130 detects a condition in the caller side of the wireline network 112_{A} (which prevents establishment of the first and second communications paths 202₁ and 202₂), detects a condition in the communication path 115 (which prevents establishment of the third communications path 202₃), and detects a condition in the callee side of the wireless network 112_{Z} (which prevents establishment of the fourth communications path 202₄). In this case, the caller may hear a busy signal at wireline caller terminal 102_{LA}, and possibly also at wireless caller terminal 102_{WA} if the call establishment request is forwarded to wireless caller terminal 102_{WA}.

Although primarily depicted and described with respect to attempting to establish calls using a specific number of networks (illustratively, two networks, i.e., a wireline network and a wireless network), the present invention may be used to attempt to establish calls using any number of networks. For example, the present invention may be used to attempt to establish calls using one wireline network, one wireless network, two wireline networks and one wireless network, and the like, as well as various combinations thereof. Although primarily depicted and described with respect to attempting to establish calls using a specific wireline network (i.e., the PSTN) and a specific wireless network (i.e., the MWN), the present invention may be used to automatically establish calls across various other wireline and/or wireless networks, as well as various other types of networks (e.g., private wireline and/or wireless networks, the Internet, and the like, as well as various combinations thereof).

Although primarily depicted and described herein with respect to an embodiment in which the caller has two caller terminals and the callee has two callee terminals, the present invention may be used for establishing calls between users having different numbers of user terminals. The present invention may be used for establishing calls from one caller terminal to one of multiple callee terminals, from one of multiple caller terminals to one callee terminal, or from one of multiple caller terminals to one of multiple callee terminals (the case primarily depicted and described herein). The case in which both the caller and callee each have multiple user terminals by which the call may be established clearly provides the greatest resiliency with respect to call establishment in accordance with the present invention.

Although primarily depicted and described herein with respect to an initial wireline-to-wireline call establishment request, the present invention may be utilized in order to provide automatic call establishment in response to any initial call establishment request, e.g., wireline-to-wireless, wireless-to-wireline, wireless-to-wireless, and the like. Although primarily depicted and described herein with respect to establishing voice calls, the present invention may be used to provide resilient signaling in order to establish various other types of connections between users (e.g., data connections, video connections, multimedia connections, and the like, as well as various combinations thereof).

Although primarily depicted and described herein with respect to attempting to establish a type of connection requested by a caller, where a request to establish a first type of connection cannot be completed, the present invention may be adapted to attempt to establish a second type of connection. For example, assuming a caller attempts to establish a voice connection from a wireline phone of the caller to a wireline phone of the callee, if the voice connection cannot be established, the present invention may attempt to establish a data connection from a wireless phone of the caller to a desktop computer of the callee. Similarly, for example assuming a caller attempts to establish a voice connection from a wireline phone of the caller to a wireless phone of the callee, if the voice connection cannot be established between any phones of the caller and callee, the present invention may attempt to establish a video connection from a laptop of the caller to a desktop computer of the callee.

Since the present invention is not limited by the number of available caller terminals, the number of available callee terminals, the numbers, types and combinations of networks over which the call establishment signaling may be routed, the types of connections which may be requested, or other like factors, the present invention may be described in more general terms. A generalized method for completing a call from one or more caller terminals to one or more callee terminals (or, more generally, between user terminals) is depicted and described herein with respect to FIG. 3. A generalized method for routing call establishing signaling from one or more caller terminals to one or more callee terminals, which may be performed within the context of the general call establishment signaling method of FIG. 3, is depicted and described herein with respect to FIG. 4.

FIG. 3 depicts a method according to one embodiment of the present invention. Specifically, method 300 of FIG. 3 includes a method for routing a call establishment request from a user terminal associated with a caller (i.e., caller terminal) to a user terminal associated with a callee (i.e., callee terminal). As described herein, the caller terminal may be one of one or more user terminals available to the caller and the callee terminal may be one of one or more user terminals available to the callee. Although depicted and described as being performed serially, at least a portion of the steps of method 300 of FIG. 3 may be performed contemporaneously, or in a different order than depicted and described with respect to FIG. 3. The method 300 begins at step 302 and proceeds to step 304.

At step 304, call establishment signaling is monitored. The call establishment signaling includes signaling associated with a request to establish a call from a first terminal of the caller to a first terminal of the callee. The call establishment signaling may include any rerouted call establishment signaling (e.g., rerouted in response to one or more network conditions). In other words, the call establishment signaling may be any signaling adapted for completing a call from a caller terminal (which may be one of many user terminals available to the caller, e.g., wireline phones, wireless phones, and the like) to a callee terminal (which may be one of many user terminals available to the callee, e.g., wireline phones, wireless phones, and the like).

For example, the call establishment signaling may be signaling from a caller terminal to a network element, signaling between network elements (which may include network elements both within and between different portions of the same network or same type of network, network elements both within and between different types of networks, and the like, as well as various combinations thereof), signaling from a network element to a callee terminal, signaling from a network element to a caller terminal, and the like, as well as various combinations thereof. The call establishment signaling may include any other signaling which may be required in order to establish a connection between a caller terminal and a callee terminal, as described herein.

At step 306, call establishment signaling is routed from one of at least one caller terminal to one of at least one callee terminal. The call establishment signaling initially routed from a first caller terminal to a first callee terminal may be rerouted to at least one of: a second terminal of the caller and a second terminal of the callee. The call establishment signaling may be rerouted in response to at least one condition in the network. The call establishment signaling may be rerouted based on the location of each of the at least one condition in the network in response to which the call establishment signaling is rerouted. The call establishment signaling may continue to be rerouted to additional terminals of the caller and/or additional terminals of the callee (assuming such additional terminals exist) in response to network conditions.

If the call can be completed between any one of the combinations of caller terminal and callee terminal, the call is completed and the caller and callee are connected (assuming that the callee answers the call). If the call cannot be completed between any of the possible combinations of available caller terminals and available callee terminals, the call is not completed and the caller and callee are not connected. In this case, the caller may hear a busy signal, or some other audible indicator, on one or more of the available caller terminals. A method for routing call establishment signaling is depicted and described herein with respect to FIG. 4. At step 308, method 300 ends.

FIG. 4 depicts a method according to one embodiment of the present invention. Specifically, method 400 of FIG. 4 includes a method for routing call establishment signaling from one or more terminals of a caller (denoted as caller terminals) to one or more terminals of a callee (denoted as callee terminals). In one embodiment, method 400 may be used as step 306 of method 300 depicted and described herein with respect to FIG. 3. Although depicted and described as being performed serially, at least a portion of the steps of method 400 of FIG. 4 may be performed contemporaneously, or in a different order than depicted and described with respect to FIG. 4. The method 400 begins at step 402 and proceeds to step 404.

At step 404, a determination is made as to whether a condition (or conditions) is detected from call establishment signaling. The condition may be detected from any call establishment signaling. For example, the condition may be detected from signaling on the caller side of one or more networks (e.g., signaling from a caller terminal to a network element, from a network element to a caller terminal, and the like), on the callee side of one or more networks (e.g., signaling from a network element to a callee terminal, and the like), at one or more network transfer/connection points for signaling between similar types of networks (e.g., wireline-to-wireline signaling, wireless-to-wireless signaling, and the like), at one or more network transfer/connection points for signaling between different types of networks (e.g., wireline-to-wireless signaling, wireless-to-wireline signaling, and the like), and the like, as well as various combinations thereof.

The condition or conditions may be any condition(s) impacting connection establishment signaling. In one embodiment, a condition which causes a change to routing of a call establishment request may be any condition which prevents propagation of call establishment signaling. For example, a condition may include a network failure (e.g., failure of one or more network elements, failure of one or more network links, and the like, as well as various combinations thereof), network congestion, and the like, as well as various combinations thereof. In one embodiment, a condition which causes a change to routing of a call establishment request may be any condition which affects call establishment signaling (e.g., a network failure, network congestion, and the like, as well as various combinations thereof).

As depicted in FIG. 4, processing is dependent on whether or not a condition is detected from call establishment signaling and, if detected, the location of the detected condition (e.g., callee side, caller side, network signaling/transfer point, and the like). If a condition(s) is not detected from call establishment signaling such that the call can be completed on both the caller end and the callee end (as well as at any required network transfer/connection point), method 400 proceeds to step 406. If a condition(s) is detected such that the call cannot complete at the callee end, method 400 proceeds to step 408. If a condition(s) is detected such that the call cannot complete at the caller end and/or the call cannot complete due to a condition(s) at a network transfer/connection point (e.g., between different portions of the same type of network, between different types of networks, and the like), method 400 proceeds to step 412.

At step 406, the call can be completed as signaled, i.e., between the caller terminal and the callee terminal (using any network transfer/connection points required to complete the call), and no action (or no further action if this is not the first loop through method 400) is required from the call establishment controller. The caller terminal with which the call is completed may or may not be the original caller terminal from which the caller attempted the call (depending on whether or not conditions were detected and, thus, the number of times method 400 looped). Similarly, the callee terminal with which the call is completed may or may not be the original callee terminal which the caller attempted to call (depending on whether or not conditions were detected and, thus, the number of times method 400 looped). The callee terminal rings and the caller terminal receives a ringback. The call may or may not be completed depending on whether or not the callee answers the incoming call. From step 406, method 400 proceeds to step 418, where method 400 ends.

At step 408, a determination is made as to whether another callee terminal is found that can be used to complete the call. As described herein, another callee terminal may be found by querying one or more systems and/or databases. If another callee terminal is found, method 400 proceeds to step 410, at which point signaling is initiated to complete the call from the caller terminal (which may be the original caller terminal or another caller terminal) to the found callee terminal. From step 410, method 400 returns to step 404 in order to determine whether additional conditions are detected from the call establishment signaling or whether the call can then be completed as signaled using the found callee terminal (i.e., proceeding to step 406). If another callee terminal is not found, method 400 proceeds to step 416, at which point the call cannot be completed and, thus, the call is abandoned. From step 416, method 400 proceeds to step 418, where method 400 ends.

At step 412, a determination is made as to whether another caller terminal is found that can be used to complete the call and/or whether another callee terminal is found that can be used to complete the call. The determination as to whether to attempt to identify another caller terminal, another callee terminal, or both another caller terminal and another callee terminal depends upon the attempted signaling of the call and the source of the detected condition or conditions. This may be better understood with respect to the examples depicted and described herein with respect to FIG. 2. For example, for a call initially attempted from wireless caller terminal 102_{WA} to wireline callee terminal 102_{LZ}, detection of congestion conditions in both communication path 115 and callee side of wireless network 122_{Z} may result in identification of wireline caller terminal 102_{LA} for use in rerouting call establishment signaling between wireline caller terminal 102_{LA} and wireline callee terminal 102_{LZ} over wireline network 10. As described herein, other caller and/or callee terminals may be found by querying one or more systems and/or databases.

If an attempt is made to identify another caller terminal (but not another callee terminal) and another caller terminal is found, method 400 proceeds to step 414. If an attempt is made to identify another callee terminal (but not another caller terminal) and another callee terminal is found, method 400 proceeds to step 414. If an attempt is made to identify both another caller terminal and another callee terminal and the other caller terminal and the other callee terminal are both found, method 400 proceeds to step 414. At step 414, signaling is initiated to complete the call from the caller terminal (which may be the original caller terminal or another identified caller terminal) to the callee terminal (which may be the original callee terminal or another identified callee terminal). From step 414, method 400 returns to step 404 in order to determine whether additional conditions are detected from the call establishment signaling or whether the call can then be completed as signaled using the caller and callee terminals (i.e., proceeding to step 406).

If an attempt is made to identify another caller terminal and another caller terminal cannot be found, method 400 proceeds to step 416 (and this is true even if another callee terminal is found since, without any available caller terminals, the call cannot be completed). If an attempt is made to find another callee terminal and another callee terminal cannot be found, method 400 proceeds to step 416 (and this is true even if another caller terminal is found since, without any available callee terminals, the call cannot be completed). At step 416, the call cannot be completed (due to a lack of one or both of an available caller device and an available callee device, and possibly also due to lack of available connectivity between portions of networks and/or between portions of different networks) and, thus, the call is abandoned. From step 416, method 400 proceeds to step 418, where method 400 ends.

Although primarily depicted and described herein with respect to establishing a connection by signaling via the first communication path identified as being available for completing call establishment signaling, in one embodiment the present invention may determine all possible communication paths available for completing call establishment signaling (e.g., based on the presence and/or absence of conditions in various locations of available networks) and attempt the complete the call establishment signaling using the available communications paths in order of desirability. In one such embodiment, the available communication paths may be ranked in order of desirability and attempts to complete the call establishment signaling using the different communication paths may be performed according to the order of desirability (e.g., trying an optimum communication path first, trying the next-best communication path second, and so on). In other words, this embodiment may be implemented in order to select an optimum route for a call establishment request where multiple communication paths are available.

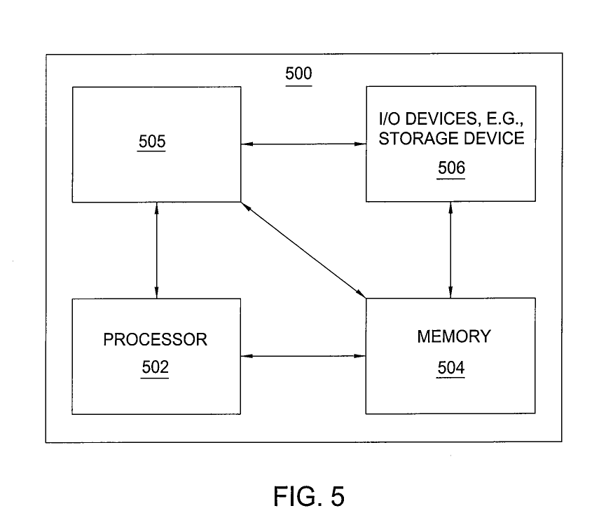

FIG. 5 depicts a high-level block diagram of a general-purpose computer suitable for use in performing the functions described herein. As depicted in FIG. 5, system 500 comprises a processor element 502 (e.g., a CPU), a memory 504, e.g., random access memory (RAM) and/or read only memory (ROM), a call establishment control module 505, and various input/output devices 506 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present call establishment control process 505 can be loaded into memory 504 and executed by processor 502 to implement the functions as discussed above. As such, call establishment control process 505 (including associated data structures) of the present invention can be stored on a computer readable medium or carrier, e.g., RAM memory, magnetic or optical drive or diskette and the like.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for establishing a call from a caller to a callee, comprising the steps of:
monitoring call establishment signaling associated with a request by a caller to establish a call from a first terminal of the caller to a first terminal of the callee;
in response to at least one condition in the network, determining a location of each of the at least one condition in the network; and
routing the call establishment signaling to at least one of a second terminal of the caller and a second terminal of the callee based on the location of each of the at least one condition in the network.

2. The method of claim 1, wherein, when the call establishment signaling is routed to the second callee terminal, the step of routing the call establishment signaling comprises the steps of:
identifying the second callee terminal of the callee; and
routing the call establishment signaling toward the identified second callee terminal.

3. The method of claim 2, wherein the step of identifying the second callee terminal comprises the steps of:
determining an identifier of the first callee terminal of the callee; and
querying a database using the first callee terminal identifier to identify the second callee terminal.

4. The method of claim 1, wherein, when the call establishment signaling is routed to the second caller terminal, the step of routing the call establishment signaling comprises the steps of:
identifying the second caller terminal of the caller; and
routing the call establishment signaling toward the identified second caller terminal.

5. The method of claim 4, wherein identifying the second caller terminal comprises the steps of:
determining an identifier of the first caller terminal of the caller; and
querying a database using the first caller terminal identifier to identify the second caller terminal.

6. The method of claim 4, wherein the step of routing the call establishment signaling toward the identified second caller terminal further comprises the step of:
propagating toward the first caller terminal a message indicative of the routing of the call establishment signaling to the second caller terminal.

7. The method of claim 6, wherein the message is presented in human perceptible form at the first caller terminal.

8. An apparatus for establishing a call from a caller to a callee, comprising:
means for monitoring call establishment signaling associated with a request by a caller to establish a call from a first terminal of the caller to a first terminal of the callee;
means for determining a location of each of at least one condition in the network; and
means for routing the call establishment signaling to at least one of a second terminal of the caller and a second terminal of the callee based on the location of each of the at least one condition in the network.

9. The apparatus of claim 8, wherein the means for routing the call establishment signaling comprises:
means for identifying the second callee terminal of the callee; and
means for routing the call establishment signaling toward the identified second callee terminal.

10. The apparatus of claim 9, wherein the means for identifying the second callee terminal comprises:
means for determining an identifier of the first callee terminal of the callee; and
means for querying a database using the first callee terminal identifier to identify the second callee terminal.

11. The apparatus of claim 8, wherein the means for routing the call establishment signaling comprises:
means for identifying the second callee terminal of the callee; and
means for routing the call establishment signaling toward the identified second callee terminal.

12. The apparatus of claim 11, wherein the means for identifying the second caller terminal comprises:
means for determining an identifier of the first caller terminal of the caller; and
means for querying a database using the first caller terminal identifier to identify the second caller terminal.

13. The apparatus of claim 11, wherein the means for routing the call establishment signaling toward the identified second caller terminal comprises:
means for propagating toward the first caller terminal a message indicative of the routing of the call establishment signaling to the second caller terminal.

14. The apparatus of claim 13, wherein the message is adapted to be presented in human perceptible form at the first caller terminal.

15. A method for establishing a call from a caller to a callee, comprising the steps of:
monitoring call establishment signaling associated with a request to establish a call from a first terminal of the caller to a first terminal of the callee; and
in response to at least one condition in the network, routing the call establishment signaling toward a second terminal of the caller.

16. The method of claim 15, wherein the at least one condition in the network comprises at least one condition preventing the call from being established to the first terminal of the caller.

17. The method of claim 15, wherein routing the call establishment signaling toward a second terminal of the caller comprises the steps of:
determining an identifier of the first caller terminal of the caller; and
querying a database using the first caller terminal identifier to identify the second caller terminal.

18. The method of claim 15, further comprising the step of:
propagating toward the first caller terminal a message indicative of attempting to establish the call to the second caller terminal.

19. The method of claim 18, wherein the message is presented in human perceptible form at the first caller terminal.

20. The method of claim 15, further comprising the step of:
in response to the at least one condition in the network, routing the call establishment signaling toward a second terminal of the callee.

21. An apparatus for establishing a call from a caller to a callee, comprising:
means for monitoring call establishment signaling associated with a request to establish a call from a first terminal of the caller to a first terminal of the callee; and
means for routing the call establishment signaling toward a second terminal of the caller in response to at least one condition in the network.

22. The apparatus of claim 21, wherein the at least one condition in the network comprises at least one condition preventing the call from being established to the first terminal of the caller.

23. The apparatus of claim 21, wherein the means for routing the call establishment signaling toward the second terminal of the caller comprises:
means for determining an identifier of the first caller terminal of the caller; and
means for querying a database using the first caller terminal identifier to identify the second caller terminal.

24. The apparatus of claim 21, further comprising:
means for propagating toward the first caller terminal a message indicative of attempting to establish the call to the second caller terminal.

25. The apparatus of claim 24, wherein the message is adapted for being presented in human perceptible form at the first caller terminal.

26. The apparatus of claim 21, further comprising:
means for routing the call establishment signaling toward a second terminal of the callee in response to the at least one condition in the network.

27. A method for establishing a call from a caller to a callee, comprising the steps of:
monitoring call establishment signaling associated with a request to establish a call from the caller to the callee; and
routing the call establishment request signaling from one of a plurality of terminals of the caller toward one of a plurality of terminals of the callee.

28. The method of claim 27, wherein the step of routing the call establishment request signaling comprises the steps of:
routing the call establishment signaling from a first caller terminal toward a first callee terminal; and
in response to an indication that the call establishment signaling cannot be routed from the first caller terminal to the first callee terminal due to at least one network condition, routing the call establishment signaling to at least one of a second caller terminal of the caller and a second callee terminal of the callee.

29. The method of claim 28, wherein routing of the call establishment signaling depends on a location of each of the at least one network condition.
